(19) United States
(12) Patent Application Publication
(10) Pub. No.: US 2026/0273611 A1
(43) Pub. Date: Sep. 17, 2026

(54) APPARATUS AND METHOD FOR SEALING CANS

(71) Applicant: KRONES AG, Neutraubling (DE)

(72) Inventors: Erwin Knieling, Pfatter (DE); Marco Leidel, Rain (DE)

(21) Appl. No.: 19/566,195

(22) Filed: Mar. 13, 2026

(30) Foreign Application Priority Data
Mar. 14, 2025 (DE) 10 2025 109 922.7

(51) Int. Cl. B21D 51/26; B21D 51/32; B65B 7/28; B65B 57/08

(52) U.S. Cl. CPC B21D 51/2653; B21D 51/32; B65B 7/285; B65B 57/08

(57) ABSTRACT

An apparatus and method for sealing cans, comprising a can body and lid, for example in a beverage bottling plant, wherein the apparatus comprises: at least one seaming tool configured to perform a sealing operation by seaming portions of the can body and lid to be joined to form a sealing composite; at least one tool monitoring device configured to detect a condition of the at least one seaming tool; and a control device in communication with the tool monitoring device and configured to determine a faulty sealing operation based on the condition detected by the tool monitoring device.

### CROSS-REFERENCE TO RELATED APPLICATIONS

This application claims priority from German Patent Application No. DE 10 2025 109 922.7, filed on Mar. 14, 2025 in the German Patent and Trademark Office, the disclosure of which is incorporated herein by reference in its entirety.

### BACKGROUND

### Technical Field

The present invention relates to an apparatus and a method for sealing cans, for example, in a beverage bottling plant.

### Related Art

Cans are used, among other things, for packaging beverages, canned food, and also goods outside the food industry. Cans, in particular those made of a metal such as tinplate, are robust, lightweight, and opaque to light and oxygen to protect the product inside.

Before filling the cans, they initially consist of two parts, comprising a can body and a lid, which are joined together only after filling to form a gas-and liquid-tight package. The sealing operation in a can sealer is carried out by a mechanical deformation process in which the can body and the lid are seamed to form a tight, usually multi-layered, composite structure. This seaming joining technique is achieved by the combined rotation of the can and lid, centered in a seaming head, along seaming rollers. In this process, forming forces are applied to the portions of the can body and lid that are to be joined together in order to create a seam, usually a double seam.

If the sealing operation, i.e., the formation of the can's seam, is not carried out flawlessly, damage or abrasion, so-called angel hair, can occur on the can and/or lid. The cause could be, for example, incorrect machine settings, or damaged or worn seaming tools.

Testing or quality control of the filled and sealed containers, in particular in case of cans, is often complex and associated with production losses, not least because of their metallic, opaque nature, which makes subsequent inspection of the can contents difficult. In this regard, it is common practice to carry out random quality control checks, comprising an inspection of the seamed joint between the can body and lid. Due to the interval of random inspections, for example 8 hours, it is possible that large quantities of defective cans are produced because, in the event of a negative control sample, all cans produced in the period between the inspections must be considered defective.

### SUMMARY

An improved apparatus and an improved method for sealing cans, for example in a beverage bottling plant, in particular to improve the quality control of the sealing operation is described herein according to various embodiments.

The apparatus and method according to the invention relate to the sealing of cans, wherein the cans are in some embodiments made of a metal or with a metallic component, such as aluminum or tinplate. Each can comprises a can body and a lid that are joined together by the sealing operation, resulting in a sealed, in certain embodiments gas-and liquid-tight container.

The cans to be sealed are usually filled with a filling product, comprising in particular beverages. The apparatus and the method are used particularly in various embodiments in a beverage bottling plant, for example for bottling (still or carbonated) water, beer, juice, soft drinks, smoothies, dairy products, mixed beverages and the like.

The apparatus includes at least one seaming tool which is configured to perform a sealing operation by seaming portions of the can body and lid to be joined to form a sealing composite. The sealing operation therefore comprises, at least in some portions, mechanical forming of the can body and/or lid.

The apparatus further comprises at least one tool monitoring device configured to detect a condition of the at least one seaming tool, and a control device in communication with the tool monitoring device and configured to determine a faulty sealing operation based on the condition detected by the tool monitoring device.

The apparatus, equipped with one or more tool monitoring devices, thus enables quality control of the sealed cans via the indirect way of monitoring the seaming tools. A gray area of sampling-based product quality assurance is eliminated. The number of potentially faulty cans, i.e., rejects, can be significantly reduced. Since the tool monitoring devices, in cooperation with the control device, automatically perform machine-side monitoring, operating errors can be eliminated or at least reduced. Condition monitoring of the seaming tools is possible continuously and without interruptions, which ultimately makes an (indirect) quality control of each individual can produced feasible. In addition to the desired quality control of the cans, tool monitoring also enables monitoring of the wear condition of the seaming tools.

The control device can be configured to initiate one or more appropriate measures upon detection of a faulty sealing operation, comprising, for example, issuing a message or warning and/or influencing subsequent sealing operations. Such intervention can comprise, for example, omitting or deactivating the affected seaming tool or stopping the apparatus or process.

The determination of a potentially faulty sealing operation based on the detected condition by the control device can be carried out in different ways. The control device is in several embodiments configured to infer a faulty sealing operation from the condition detected by the tool monitoring device if the condition and/or a change in the condition over time are outside a permissible range. If the detected condition or a change thereof deviates from the permissible range, it can be assumed that there is damage to the seaming tool in question that could impair the quality of the cans. The defined, permissible range can be obtained based on empirical values and/or through observation. The permissible range can, for example, be defined as a parameter range and/or by one or more threshold values.

Alternatively or additionally, the control device can be configured to determine a faulty sealing operation of the condition detected by the tool monitoring device by comparison with a model calculation and/or input into an AI model.

Alternatively or additionally, it is possible to compare the conditions of several seaming tools, wherein a deviation of one tool condition or few tool conditions from the other tool conditions indicates a fault condition of the seaming tool(s) in question. In this case, the control device is configured to detect a faulty sealing operation of one of the seaming tools by comparing it with the conditions of the other seaming tools. Determining a potentially faulty sealing operation is therefore possible even without comparison with permissible ranges (parameter ranges, threshold values, etc.) and without using models and the like, by comparing the conditions of different seaming tools.

In one or more embodiments, the at least one tool monitoring device has one or more cameras for optical detection of a condition of the at least one seaming tool. In this regard, the control device can be configured to detect a faulty sealing operation, for example in case of increased wear and/or abrasion and/or angel hair and/or damage to the at least one seaming tool and/or in case of a missing can body and/or lid. In this way, the quality of the sealing operation, in particular of the can seam, can be assessed based on a visual inspection of the seaming tool in question. Optical monitoring using one or more cameras has a particular advantage in that any damage or the like can be detected with very short response time and appropriate measures (issuing a warning, omitting affected seaming stations, stopping the machine, etc.) can be taken very quickly by the control device.

Alternatively or additionally, the at least one tool monitoring device has at least one temperature sensor which is configured to detect a temperature as a condition of the at least one seaming tool. Temperature measurement can be done through contact or without contact, for example using a pyrometer. If the temperature value at the seaming tool deviates from a permissible range or relative to other seaming tools, it is likely that there are abnormalities at the capper that could impair can quality.

As an alternative or in addition to an optical and/or temperature-based tool monitoring device, tool monitoring can also be based on another technical principle, for example on force measurement, acceleration measurement, etc. of the seaming tool to be monitored.

In several embodiments, the at least one seaming tool comprises a seaming head and/or one or more seaming rollers. In such case, the seamed joint between the can body and lid is produced by rotating the can body and lid together, centered by the seaming head, along the seaming roller(s). The seaming head has the task of putting the can body and lid into rotation by a certain head pressure (axial force relative to the can) and rotating the can body and lid past the seaming rollers. The seaming head and the seaming rollers have a tool contour that is a negative profile of the target contour of the can/lid composite.

In some embodiments, exactly two seaming rollers, in particular with different tool contours, are used per can during the sealing operation: one seaming roller for pre-deformation and one seaming roller for final deformation.

In certain embodiments, the at least one seaming tool comprises a seaming head and one or more seaming rollers, wherein the temperature sensor is configured to detect a temperature of at least one of the seaming rollers, but in one embodiment not of the seaming head, making tool monitoring simple yet reliable in engineering terms.

In one or more embodiments, the apparatus is configured as a rotary-type apparatus, i.e., in such case, it comprises a capper carousel and several seaming tools installed on the outer circumference of the capper carousel. In this way, a continuous stream of cans can be processed in a structurally compact manner.

The one or more tool monitoring devices are in some embodiments arranged outside the working area of the seaming tools. For example, the tool monitoring devices can be installed outside the capper carousel and in a stationary position relative thereto, and/or directed towards a region of the capper carousel that lies between a capper infeed starwheel and a capper outfeed starwheel.

Alternatively, it is also possible to install one or more tool monitoring devices on the capper carousel or running alongside the capper carousel, wherein in such case, for example, a separate tool monitoring device can be assigned to a seaming station or a group of seaming stations.

A method for sealing cans, for example in a beverage bottling plant, wherein the method includes: performing a sealing operation by seaming the portions of the can body and lid to be joined such as to form a sealing composite using a seaming tool; detecting a condition of the seaming tool using a tool monitoring device; and determining a faulty sealing operation based on the condition detected by the tool monitoring device using a control device that is in communication with the tool monitoring device.

The features, technical effects, advantages along with exemplary embodiments that have been described with respect to the apparatus apply analogously to the method.

For the reasons mentioned above, the control device in one embodiment infers a faulty sealing operation from the condition detected by the tool monitoring device if the condition and/or a change in the condition over time are outside a permissible range. Alternatively or additionally, the control device determines a faulty sealing operation of the condition detected by the tool monitoring device by comparison with a model calculation and/or input into an AI model.

In one or more embodiments, several seaming tools are provided, wherein the tool monitoring device detects a condition of each of the seaming tools and the control device, for the reasons mentioned above, determines a faulty sealing operation of one of the seaming tools by comparison with the conditions of the other seaming tools.

In some embodiments, for the reasons mentioned above, the tool monitoring device comprises one or more cameras for optical detection of a condition of the seaming tool, wherein the control device detects, for example, a faulty sealing operation in case of increased wear and/or abrasion and/or angel hair and/or damage to the seaming tool and/or in case of a missing can body and/or lid.

In certain embodiments, for the reasons mentioned above, the tool monitoring device has at least one temperature sensor that detects a temperature as a condition of the at least one seaming tool, wherein the temperature sensor is in one embodiment a non-contact temperature sensor, such as a pyrometer.

In several embodiments, the at least one seaming tool comprises a seaming head and one or more seaming rollers, wherein the temperature sensor detects a temperature of at least one of the seaming rollers for the reasons mentioned above, but in one embodiment not of the seaming head.

Further advantages and features of the present invention are apparent from the following description of exemplary embodiments. The features described therein can be implemented on a stand-alone basis or in combination with one or more of the features set forth above, provided the features do not contradict one another. The following description of exemplary embodiments is made with reference to the accompanying drawings.

### BRIEF DESCRIPTION OF THE FIGURES

Further embodiments of the invention are explained in more detail by the following description of the figures. In the figures:

FIG. 1 schematically shows a section of an apparatus for sealing cans and having a tool monitoring device;

FIG. 2 shows a larger section of the apparatus for sealing cans; and

FIG. 3 shows a schematic top view of a capper carousel with a capper infeed starwheel arranged upstream and a capper outfeed starwheel arranged downstream thereof.

### DETAILED DESCRIPTION

Exemplary embodiments are described below with reference to the figures. In doing so, identical, similar or similarly acting elements are provided with identical reference signs in the figures, and a repeated description of such elements is partially omitted in order to avoid redundancy.

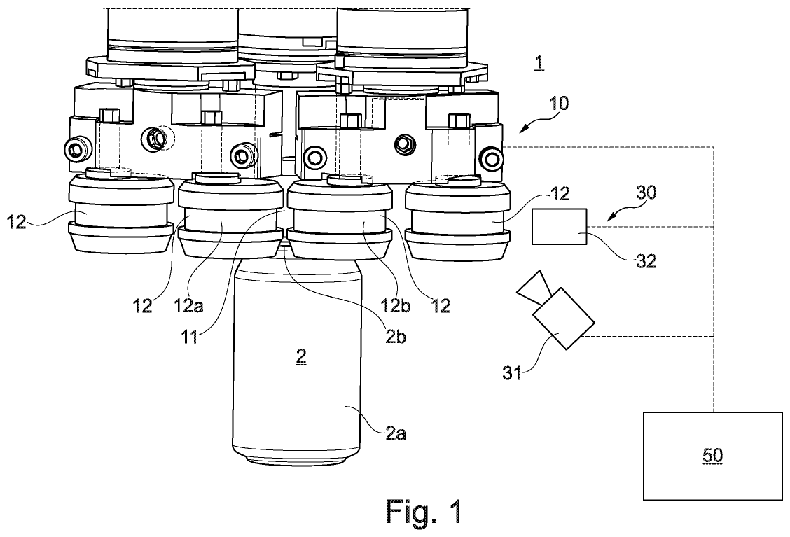

FIG. 1 is a schematic view of a section of an apparatus 1 for sealing cans 2. In one embodiment, the cans are cans made of a metal or with a metallic component such as aluminum or tinplate.

The cans 2 to be sealed are filled with a filling product, comprising in particular beverages. The apparatus 1 is used in several embodiments in a beverage bottling plant, for example for bottling (still or carbonated) water, beer, juice, soft drinks, smoothies, dairy products, mixed beverages and the like.

The can 2 comprises a can body 2a and a lid 2b that are joined together by the sealing process, resulting in a gas-and liquid-tight container. In the sealing process, the portions of the can body 2a and the lid 2b to be joined are seamed to form a tight, in particular multi-layered, composite using one or more suitable seaming tools 10.

In the present exemplary embodiment, the seaming tools 10 comprise a seaming head 11 and several seaming rollers 12. The seamed joint is produced by rotating the can body 2a and lid 2b together, centered by the seaming head 11, along the seaming rollers 12. The seaming head 11 has the opposite contour of the target contour of the seamed lid 2b. The seaming head 11 has the task of putting the can body 2a and the lid 2b into rotation by a certain head pressure (axial force relative to the can 2) and rotating the can body 2a and lid 2b past the seaming rollers 12. The seaming rollers 12 have a tool contour that is a negative profile of the target contour of the can/lid composite. Certain forming forces are required for the deformation process, which lead to a temperature increase at the seaming tools 10, i.e., seaming rollers 12 and/or seaming head 11, during the seaming operation.

In one or more embodiments, exactly two seaming rollers 12 with possibly different tool contours are used per can 2 during the sealing process: one seaming roller 12a for pre-deformation and one seaming roller 12b for final deformation.

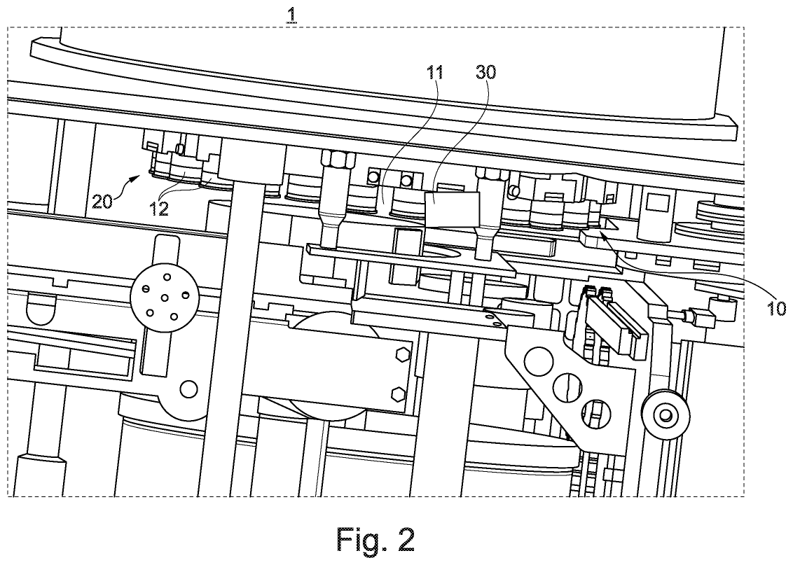

FIG. 2 shows a larger section of the apparatus 1, from which it can be seen that the seaming tools 10, comprising several seaming heads 11 and seaming rollers 12 assigned in pairs, are arranged on the outer circumference of a common capper carousel 20. The filled can bodies 2a and associated lids 2b (not shown in FIG. 2) are suitably fed to the capper carousel 20 and joined together during a substantially complete rotation or at least along a partial circle of the capper carousel 20 by the seaming process described above, thereby producing sealed, liquid-and gas-tight cans 2.

The seaming or sealing process is controlled and/or regulated and, if necessary, monitored by a control device 50 (see FIG. 1). For this purpose, the control device 50 is in communication with the components of the apparatus 1 to be controlled and possibly read out, i.e., in particular with the seaming tools 10 and the capper carousel 20, and is configured to control and/or regulate the sealing process. Communication can be wired or wireless, digital or analog. Communication does not necessarily have to involve an exchange of information in both directions. In this context, a unidirectional flow of data and/or signals falls under the term “communication.” The control device 50 does not necessarily have to be formed by a central computing device or electronic control system, but rather comprises decentralized and/or multi-stage systems, control networks, cloud systems and the like. The control device 50 can also be an integral part of, or communicate with, a higher-level plant control system.

The apparatus 1 further comprises a tool monitoring device 30, which is configured to monitor the condition of one, several or in one embodiment all seaming tools 10. The tool monitoring device 30 is in communication with the control device 50, so that the control device 50 can receive signals and/or data from the tool monitoring device 30 and evaluate them. The purpose of condition monitoring of the seaming tools 10 is to detect deviations from a normal condition in order to be able to have the control device 50 infer potential errors in the sealing operation.

According to one exemplary embodiment, the tool monitoring device 30 comprises at least one camera 31 with which deviations from the normal condition can be optically detected, for example increased wear of one or more seaming tools 10, abrasion, angel hair, damage, missing can bodies 2a and/or lids 2b, etc., which may impair the quality of the can seam. The normal condition of a seaming tool 10, relative to which deviations are measured, can be provided as a defined range based on empirical values, observations or the like.

Using a camera 31 as at least one component of the tool monitoring device 30, the seaming tools 10 can be visually inspected for example for atypical abrasion or damage, wherein in certain embodiments both the seaming rollers 12 and the seaming heads 11 are monitored. Optical monitoring using one or more cameras 31 has a particular advantage in that any damage can be detected with very short response time and appropriate measures (issuing a warning, omitting affected seaming stations, stopping the machine, etc.) can be taken very quickly.

An additional or alternative monitoring principle can be based on a temperature measurement of one, several or all seaming tools 10. For this purpose, the tool monitoring device 30 comprises one or more temperature sensors 32 which are configured to detect the temperature of the corresponding seaming tools 10. This can be done through contact or without contact, for example using a pyrometer. The control device 50 can initiate appropriate measures in the event of temperature deviations from a normal process (normal temperature, for example, 55° C. to 70° C.; deviation in case of fault, for example, >80° C.), such as issuing a message and/or influencing the sealing process, for example, omitting affected seaming stations or stopping the system or the process. As in the case of the camera, the control device 50 can define a permissible temperature range. If the detected seaming tool temperature deviates from the permissible range, it can be assumed that there is damage to the seaming tool 10 which could impair the quality of the cans. The defined, permissible range can be validated and adjusted based on empirical values and/or through observation. Temperature measurement is in several embodiments only carried out on the seaming rollers 12, i.e., excluding the seaming head 11.

As an alternative or in addition to an optical and/or temperature-based tool monitoring device 30, tool monitoring can also be based on another technical principle, for example on force measurement, acceleration measurement, etc. of the seaming tool 10 to be monitored.

To determine a possible fault condition of a seaming tool 10, it was described above that the tool conditions detected by the tool monitoring device 30 (optical condition, temperature, force, acceleration, etc.) are compared with a permissible range. However, detection of a fault condition can also be carried out in other ways, for example by recording a change in condition (temperature change, etc.) and comparing it with a permissible change range. Alternatively, it is possible to compare the tool conditions of several seaming tools 10, wherein a deviation of one or a small number of tool conditions from the other tool conditions indicates a fault condition of the seaming tool(s) 10 in question. Alternatively or additionally, the detected tool conditions can be compared with model calculations or fed to a suitably trained AI, which then outputs error messages depending on the input.

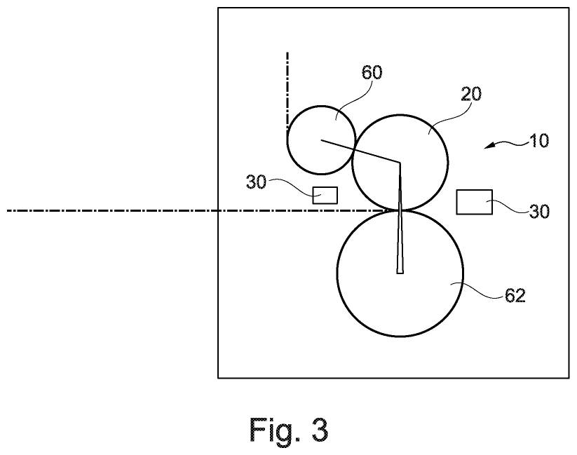

The one or more tool monitoring devices 30 are in various embodiments arranged outside the working area of the seaming tools 10. For example, the tool monitoring devices 30 can be installed outside the capper carousel 20 and in a stationary position relative thereto, and/or directed towards a region of the capper carousel 20 that lies between a capper infeed starwheel 60 (as schematically shown in FIG. 3) and a capper outfeed starwheel 62 (as schematically shown also in FIG. 3). However, it is also possible to install one or more tool monitoring devices 30 on the capper carousel 20 or running alongside the capper carousel 20, wherein in such case, for example, a separate tool monitoring device 30 can be assigned to a seaming station or a group of seaming stations. The apparatus 1, equipped with one or more tool monitoring devices 30, enables quality control of the sealed cans 2 via the indirect way of monitoring the seaming tools 10. A gray area of sampling-based product quality assurance is eliminated. The number of potentially faulty cans 2, i.e., rejects, can be significantly reduced. Since the tool monitoring devices 30, in cooperation with the control device 50, automatically perform machine-side monitoring, operating errors can be eliminated or at least reduced. Condition monitoring of the seaming tools 10 is possible continuously and without interruptions, which ultimately makes an (indirect) quality control of each individual can 2 produced feasible. In addition to the desired quality control of the cans 2, tool monitoring also enables monitoring of the wear condition of the seaming tools 10.

To the extent applicable, any of the individual features set forth in the exemplary embodiments may be combined and/or interchanged, without departing from the scope of the invention.

What is claimed is:

1. An apparatus for sealing cans, wherein each can comprises a can body and a lid, and the apparatus comprises:
a seaming tool that is configured to perform a sealing operation by seaming portions of the can body and the lid to enable the can body and the lid to be joined and a sealing composite to be formed;
a tool monitoring device that is configured to detect a condition of the seaming tool; and
a control device in communication with the tool monitoring device and configured to determine a faulty sealing operation based on the condition detected by the tool monitoring device.

2. The apparatus of claim 1, wherein the faulty sealing operation is determined when the condition and/or a change in the condition over time is outside a permissible range.

3. The apparatus of claim 1, wherein the faulty sealing operation is determined further by a comparison with a model calculation and/or an input into an artificial intelligence (AI) model.

4. The apparatus of claim 1, further comprising one or more additional seaming tools, wherein each seaming tool of the one or more additional seaming tools is configured to perform a sealing operation by seaming portions of the can body and the lid that enables the can body and the lid to be joined and a sealing composite to be formed.

5. The apparatus of claim 4, wherein the tool monitoring device is further configured to detect a condition of each of the one or more additional seaming tools and the control device is further configured to determine a faulty sealing operation of one of the one or more additional seaming tools by a comparison with conditions of the other seaming tools of the one or more additional seaming tools.

6. The apparatus of claim 1, wherein the tool monitoring device comprises one or more cameras configured to optically detect the condition of the seaming tool.

7. The apparatus of claim 1, wherein the faulty sealing operation is determined further based on increased wear, abrasion, angel hair, and/or damage to the seaming tool and/or a missing can body and/or lid.

8. The apparatus of claim 1, wherein the tool monitoring device comprises a temperature sensor that is configured to detect a temperature as the condition of the seaming tool.

9. The apparatus of claim 8, wherein the temperature sensor comprises a non-contact temperature sensor.

10. The apparatus of claim 8, wherein the seaming tool comprises a seaming head and one or more seaming rollers.

11. The apparatus of claim 10, wherein the temperature sensor is further configured to detect a temperature of at least one of the seaming rollers of the one or more seaming rollers, but not the seaming head.

12. The apparatus of claim 1, wherein the tool monitoring device is arranged outside a working area of the seaming tool.

13. The apparatus of claim 1, further comprising a capper carousel and one or more additional seaming tools installed on an outer circumference of the capper carousel.

14. The apparatus of claim 13, wherein the tool monitoring device is installed outside the capper carousel and in a stationary position relative thereto and/or is directed towards a region of the capper carousel that lies between a capper infeed starwheel and a capper outfeed starwheel and/or is installed on the capper carousel or running alongside the capper carousel.

15. A method for sealing cans, wherein each can comprises a can body and a lid, and the method comprises:
performing a sealing operation by seaming portions of the can body and the lid to enable the can body and the lid to be joined and a sealing composite to be formed using a seaming tool;
detecting a condition of the seaming tool using a tool monitoring device; and
determining a faulty sealing operation based on the condition detected by the tool monitoring device using a control device that is in communication with the tool monitoring device.

16. The method according to claim 15, wherein the control device determines the faulty sealing operation when the condition and/or a change in the condition over time is outside a permissible range, and/or
the control device further determines the faulty sealing operation based on a comparison with a model calculation and/or an input into an artificial intelligence (AI) model.

17. The method of claim 15, further comprising providing one or more additional seaming tools, wherein:
each seaming tool of the one or more additional seaming tools is configured to perform a sealing operation by seaming portions of the can body and the lid that enables the can body and the lid to be joined and a sealing composite to be formed,
the tool monitoring device detects a condition of each of the one or more additional seaming tools, and
the control device determines a faulty sealing operation of one of the one or more additional seaming tools by comparison with conditions of the other seaming tools of the one or more additional seaming tools.

18. The method of claim 15, wherein the tool monitoring device comprises one or more cameras configured to optically detect the condition of the seaming tool, and
the control device further determines the faulty sealing operation based on increased wear, abrasion, angel hair and/or damage to the seaming tool and/or a missing can body and/or lid.

19. The method of claim 15, wherein the tool monitoring device comprises a temperature sensor that detects a temperature as the condition of the seaming tool and the temperature sensor comprises a non-contact temperature sensor.

20. The method of claim 19, wherein the seaming tool comprises a seaming head and one or more seaming rollers, and the temperature sensor detects a temperature of at least one of the one or more seaming rollers, but not the seaming head.
